(19) United States
(12) Patent Application Publication
(10) Pub. No.: US 2009/0113941 A1
(43) Pub. Date: May 7, 2009

(54) WASHING MACHINE AND ASSEMBLING METHOD THEREOF

(75) Inventor: Chang Hoo Kim, Gyeyang-gu (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/261,236

(22) Filed: Oct. 30, 2008

(30) Foreign Application Priority Data
Nov. 5, 2007 (KR) 10-2007-0112004
Nov. 5, 2007 (KR) 10-2007-0112005
Nov. 5, 2007 (KR) 10-2007-0112006

(51) Int. Cl. D06F 37/20; B23P 19/04

(52) U.S. Cl. 68/140; 29/700

(57) ABSTRACT

The washing machine includes a tub, a bearing housing provided to the tub by injection molding such that a fastening part of the bearing housing is exposed to an outside of the tub, and a stator coupled to the fastening part. The washing machine suppresses generation of noise and vibration during a washing operation and has a motor firmly attached to the washing machine.

### BACKGROUND OF THE INVENTION

1. Field of the Invention

The present invention relates to a washing machine and an assembling method thereof, and more particularly to a washing machine configured to suppress noise and vibration during a washing operation and to have a motor firmly attached to the washing machine, and an assembling method thereof.

2. Description of the Related Art

FIG. 1 is a cross-sectional view of a conventional washing machine, and FIG. 2 is an enlarged cross-sectional view of part A shown in FIG. 1, illustrating a drive unit of the conventional washing machine.

Referring to FIGS. 1 and 2, the conventional washing machine includes a tub 2 disposed inside a cabinet 1, a drum 3 within the tub 2, a shaft 4 axially connected to the drum 3 to deliver a driving force from a motor 5 to the drum 3, and a bearing on an outer peripheral surface at both ends of the shaft 4. A bearing housing 7 is mounted at a center of a rear wall 30 of the tub 2 to hold the bearing at either end of the shaft 4. The bearing housing 7 is inserted during injection molding of the tub 2.

A rotor 13 is fastened to a center of the rear end of the shaft 4 and a stator 14 is fastened to the rear wall 30 of the tub 2 inside the rotor 13, constituting a direct motor 5.

A hub 31 is disposed on the rear wall 30 of the tub 2 such that the bearing housing 7 can be inserted into the hub 31 when injection molding the tub 2. Fastening bosses 32 are circumferentially arranged at constant intervals on the surface of the hub 31 and secure the stator 14 to the rear wall of the tub 2 with fasteners 15a.

A supporter 17 is interposed between the rear wall 30 of the tub 2 and the stator 14 to support the stator 14. A plurality of fasteners 15d is coupled to an inner surface of the outer periphery of the supporter 17 to fasten the supporter 17 to the rear wall 30 of the tub 2, and other fasteners 15a are provided to secure the stator 14 to the supporter 17.

In the conventional washing machine, since the stator is mounted on the supporter after the supporter is provided to the rear wall of the tub, a number of bosses and fasteners are required to fasten such components, which makes the mounting structure complicated.

In the conventional washing machine, the supporter is mounted on the tub, which is made of plastic. As a result, the tub can be deformed by an external force during fastening of the supporter, preventing the stator from being accurately positioned, and making it difficult to keep concentricity of the stator. Further, components of the washing machine are likely to interfere with one another, which can cause noise and vibration. Hence, there is a need for solving these problems of the conventional washing machine.

### SUMMARY OF THE INVENTION

The present invention is conceived to solve the problems of the conventional washing machine, and an aspect of the present invention is to provide a washing machine that has a simple mounting structure to reduce the number of components used for assembling the washing machine, and an assembling method thereof.

Another aspect of the present invention is to provide a washing machine that has an improved mounting structure to allow components to be accurately assembled to desired locations, and an assembling method thereof.

A further aspect of the present invention is to provide a washing machine configured to suppress noise or vibration during a washing operation, and an assembling method thereof.

Yet another aspect of the present invention is to provide a washing machine configured to enhance fastening strength between components, and an assembling method thereof.

Yet another aspect of the present invention is to provide a washing machine that has an improved coupling structure to improve assembling efficiency, and an assembling method thereof.

In accordance with one aspect of the present invention, a washing machine includes: a tub; a bearing housing provided to the tub by injection molding such that a fastening part can be exposed to an outside; and a stator coupled to the fastening part.

The fastening part may be disposed to protrude from a rear wall of the tub.

The fastening part may include a fastening aperture. In one embodiment, the fastening aperture has a thread formed therein. In another embodiment, a portion having the fastening aperture formed therein protrudes from the fastening part. In a further embodiment, the stator includes a latch jaw formed at a portion of the stator corresponding to the fastening aperture.

The washing machine may further include a bracket supporting the stator and urging the stator toward the bearing housing. The fastening part may be disposed to protrude from the rear wall of the tub. The fastening part may include a fastening aperture, and a portion having the fastening aperture formed therein may protrude from the fastening part. The bracket may include a coupling hole corresponding to a through-hole formed in the stator; a penetration hole through which a shaft passes; and a slant section in which a rim of the penetration hole is slanted toward the tub. The bracket may further include a cooling hole through which heat generated from the bearing housing is emitted. In addition, an inner side of the bracket may be supported by a rear end of the tub. The inner side of the bracket may closely contact an outer peripheral surface of the rear end of the tub. In addition, the inner side of the bracket may be supported by a rear end of the bearing housing. The inner side of the bracket may closely contact an outer peripheral surface of the rear end of the bearing housing.

The washing machine may further include a coupling part coupling the stator and the bracket. The coupling part may include a fastening hole formed in the stator, and an assistant coupling part formed on the bracket at a location corresponding to the fastening hole.

In accordance with another aspect of the present invention, a method for assembling a washing machine includes: forming a bearing housing; and inserting the bearing housing into a tub by injection molding, with the bearing housing supported by a jig, such that a fastening part of the bearing housing is exposed to an outside of the tub.

The step of inserting the bearing housing is performed such that the fastening part is formed to protrude to the outside.

The step of inserting the bearing housing may be performed while the fastening part is supported by the jig.

The method may further include: coupling a stator to the fastening part; coupling a bracket to the stator; and fastening the bracket, stator and fastening part with a fastening member.

In accordance with a further aspect of the present invention, a method for assembling a washing machine includes: forming a bearing housing; inserting the bearing housing into a tub by injection molding, with the bearing housing supported by a jig, such that a fastening part of the bearing housing is exposed to an outside of the tub; coupling the bracket and the stator; coupling the coupled bracket and stator to the fastening part; and fastening the bracket, stator and fastening part with a fastening member.

The step of inserting the bearing housing may be performed such that the fastening part is formed to protrude to the outside.

The step of inserting the bearing housing may be performed when the fastening part is supported by the jig.

In accordance with yet another aspect of the present invention, a washing machine includes a tub; a bearing housing provided to the tub by injection molding such that a fastening aperture can be exposed to an outside of the tub; and a stator coupled to the fastening aperture.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is a cross-sectional view of a conventional washing machine;

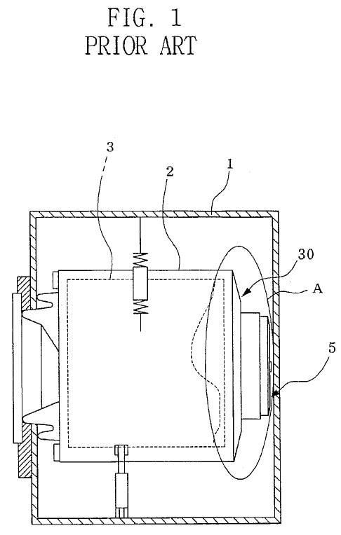

FIG. 2 is an enlarged cross-sectional view of part A shown in FIG. 1, illustrating a drive unit of the conventional washing machine;

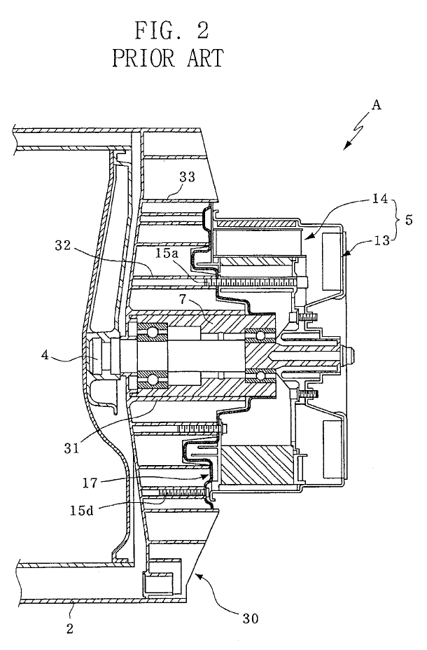

FIG. 3 is an exploded perspective view of a stator mounting structure of a washing machine according to one embodiment of the present invention;

FIG. 4 is a cross-sectional view of the stator mounting structure of the washing machine of FIG. 3;

FIG. 5 is a perspective view of a bearing housing of the stator mounting structure of FIG. 3;

FIG. 6 is a detailed view of part B shown in FIG. 4;

FIG. 7 is an exploded cross-sectional view of the stator mounting structure of FIG. 3;

FIG. 8 is a flow chart of a method for assembling a washing machine employing the stator mounting structure of FIG. 3,

FIG. 9 is a cross-sectional view of a stator mounting structure of a washing machine according to another embodiment of the present invention;

FIG. 10 is a detailed view of part C shown in FIG. 9;

FIG. 11 is an exploded cross-sectional view of the stator mounting structure of FIG. 9; and

FIG. 12 is a flow chart of a method for assembling a washing machine employing the stator mounting structure of FIG. 9.

### DETAILED DESCRIPTION OF THE INVENTION

Exemplary embodiments of the present invention will be described in detail with reference to the accompanying drawings. For descriptive convenience, the present invention will be described based on a drum type washing machine. The drawings are not to precise scale and may be exaggerated in thickness of lines or size of components for descriptive convenience and clarity only. Furthermore, terms used herein should be defined in consideration of functions of components of the present invention and thus can be changed according to the custom or intention of users or operators. Therefore, definition of such terms should be determined according to overall disclosures set forth herein.

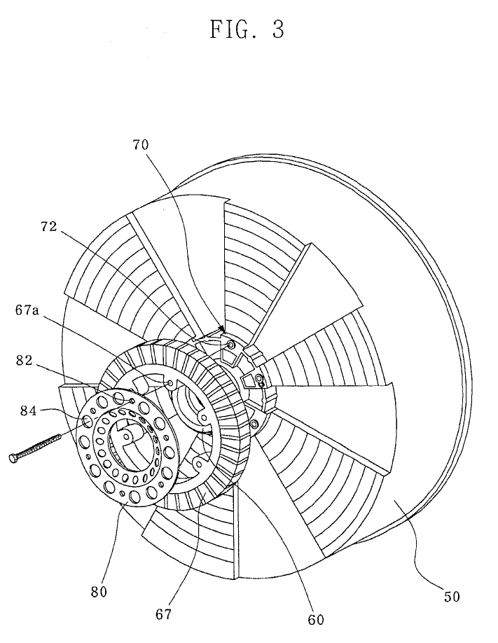

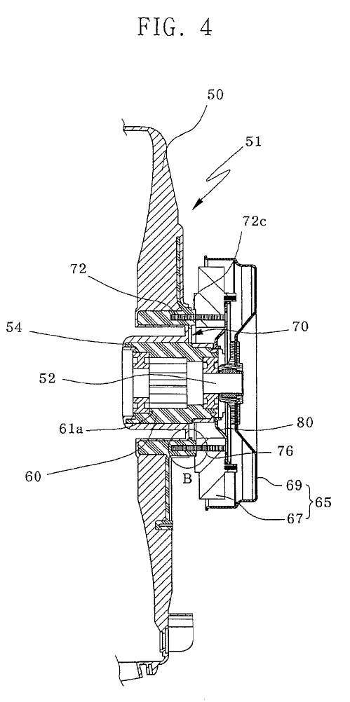

FIG. 3 is an exploded perspective view of a stator mounting structure of a washing machine according to one embodiment of the present invention, and FIG. 4 is a cross-sectional view of the stator mounting structure of FIG. 3.

Referring to FIGS. 3 and 4, the washing machine of this embodiment includes a tub 50, a bearing housing 60, a stator 67, and a bracket 80.

The bearing housing 60 rotatably supports a shaft 52, and is provided to the tub 50 by injection molding such that a fastening part 70 of the bearing housing 60 can be exposed to the outside of the tub. Since the tub 50 is injection-molded to allow the fastening part 70 to be exposed to the outside, the tub 50 can be formed while the exposed fastening part 70 is secured by a jig (not shown). In this manner, since the tub 50 is injection-molded while the fastening part 70 is secured by the jig (not shown), it is possible to accurately place the bearing housing 60 at the desired location with respect to the tub 50. Then, the fastening part 70, protruding from a rear wall 51 of the tub 50, serves to maintain concentricity between the bearing housing 60 and the tub 50 by preventing the concentricity between the bearing housing 60 and the tub 50 from being disturbed. Since the concentricity between the bearing housing 60 and the tub 50 is maintained as described above, concentricity between the stator 67 mounted to the bearing housing 60 and a rotor 69 mounted to the shaft 52 is also maintained. Further, since a uniform distance between the tub 50 and a drum (not shown) coupled to the shaft 52 can be maintained, it is possible to prevent deformation or damage resulting from interference between the tub 50 and the drum during operation of the washing machine. In this manner, since the interference between the tub 50 and the drum is suppressed, it is possible to reduce the size of the tub 60 and/or the drum. Namely, the washing machine can be reduced in size.

In this embodiment, the bearing housing 60 is made of metal, and the tub 50 is made of plastic. Preferably, the bearing housing 60 is made of aluminum or aluminum alloys in view of characteristics of the bearing housing 60 that rotates at high speed. In other embodiments, the tub 50 can be made of metal, and the bearing housing 60 can be made of plastic. Alternatively, both the tub 50 and the bearing housing 60 can be made of the same material, plastic or metal. When both the tub 50 and the bearing housing 60 are made of metal, they can be formed by die casting and the like. A detailed configuration of the bearing housing 60 will hereinafter be described with reference to the accompanying drawings.

The stator 67 is coupled to the fastening part 70. Since the stator 67 is coupled to the fastening part 70 which is made of the metal, it is possible to prevent the location of the stator 67 from being varied by the applied fastening force when coupling the stator 67. In other words, when coupling the stator 67 to the tub 50, which is made of the plastic, there can be partial deformation at the location where the stator 67 is coupled to the tub 50 caused by the fastening force. According to this embodiment, however, since the stator 67 is coupled to the metallic fastening part 70, it is possible to prevent the partial deformation. Further, the fastening part 70 may protrude from the rear wall of the tub 50 in order to permit easy coupling of the stator 67.

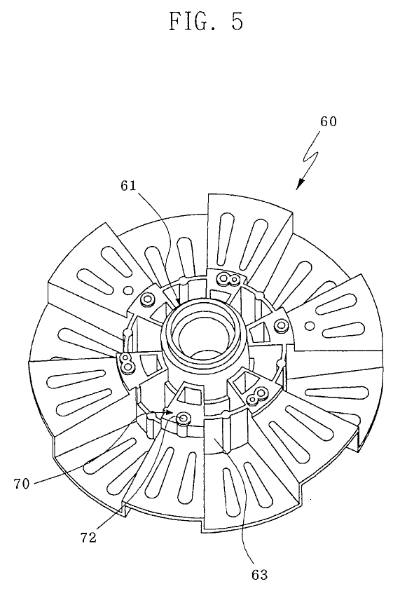

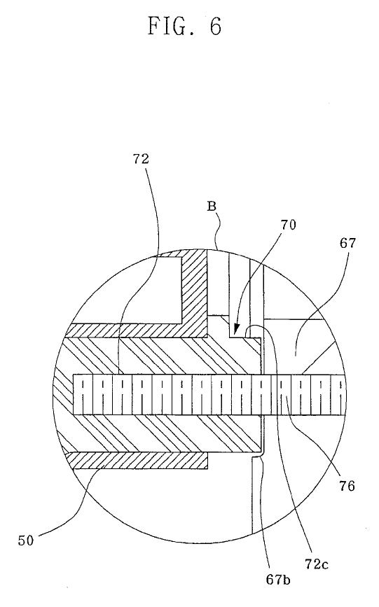

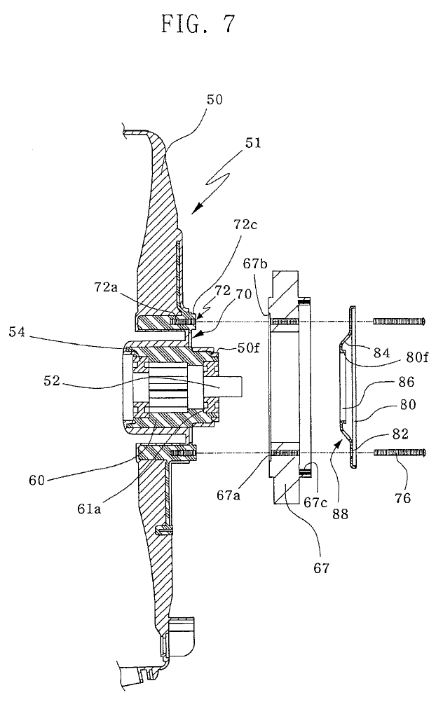

FIG. 5 is a perspective view of a bearing housing of the washing machine according to this embodiment of the present invention, FIG. 6 is a detailed view of part B shown in FIG. 4, and FIG. 7 is an exploded cross-sectional view of the stator mounting structure of the washing machine according to this embodiment of the present invention.

Referring to FIGS. 3, and 5 to 7, the bearing housing 60 is formed with a bore 61 in which the shaft 52 is rotatably supported. The bore 61 is formed through the center of the bearing housing 60 and receives the shaft 52. The bore 61 has steps 61a formed on an inner wall of the bore 61 such that a bearing 54 can be disposed on each step 61a.

The bearing housing 60 is formed with the fastening part 70. The fastening part 70 is separated by a predetermined distance from the bore 61, and is disposed to be exposed or protrude from the rear wall of the tub 50. A rib 63 is disposed between pieces of the fastening part 70 in order to prevent deformation of the bearing housing 60 due to vibration generated during operation of the washing machine. The rib 63 is circumferentially or radially disposed.

The fastening part 70 includes a fastening aperture 72, and the stator 67 is formed with a through-hole 67a at a location corresponding to the fastening aperture 72. The bearing housing 60 and the stator 67 are coupled to each other by means of a first fastening member 76 which is inserted into the fastening aperture 71 and through-hole 67a. In this regard, the fastening aperture 72 is formed with threads which engage with the first fastening member 76.

According to one embodiment, a portion 72c having the fastening aperture 72 formed therein extends from the fastening part 70. The stator 67 is coupled to the portion 72c of the fastening part 70 where the fastening aperture 72 is formed. Since the portion 72c having the fastening aperture 72 formed therein extends from the fastening part 70, the stator 67 can be coupled to the bearing housing 60 without any interference with other components.

Alternatively, although not shown in the drawings, the fastening aperture 72 may be designed to be exposed from the rear wall of the tub 50, or the portion 72c of the fastening part 70 may be designed to protrude from the rear wall of the tub 50 rather than from the bearing housing 60. More specifically, the fastening part 70 can be disposed to be inserted into the tub 50, and the fastening aperture 72 to be coupled to the stator 67 or the portion 72c having the fastening aperture 72 formed therein can be disposed to protrude from the rear wall of the tub 50.

The stator 67 is formed with a latch jaw 67b corresponding to the portion 72c of the fastening part 70 where the fastening aperture 72 is formed. The portion 72c of the fastening part 70 is inserted inside the latch jaw 67b of the stator 67 when the stator 67 is coupled to the bearing housing 60, allowing the stator 67 to be accurately mounted to the bearing housing 60. In this embodiment, since the stator 67 is directly coupled to the bearing housing 60, which is made of metal, without interposition of other members, the stator 67 can be accurately coupled to a desired location of the bearing housing 60.

Further, the stator 67 is formed with a seating recess 67c. The seating recess 67c is formed at a location corresponding to the bracket 80 on the rear wall of the stator 67 for easy coupling between the bracket 80 and the stator 67.

The bracket 80 supports the stator 67 and forces the stator 67 toward the bearing housing 60. The bracket 80 includes coupling holes 82 formed at locations corresponding to the through-holes 67a, a penetration hole 86 through which the shaft 52 passes, and a slant section 88 in which a rim of the penetration hole 86 is angled toward the tub 50. With the bracket 80 inserted into the seating recess 67c of the stator 67, which in turn is disposed on the fastening part 70 of the bearing housing 60, the first fastening member 76 is inserted into the coupling hole 82 and the through-hole 67a and is then coupled to the fastening aperture 72, so that the stator 67 and the bracket 80 are coupled to the bearing housing 60. At this point, the first fastening member 76 compresses the bracket 80 toward the stator 67, and the bracket 80 makes point contacts, line contacts, or in-plane contact with the stator 67 at plural locations. That is, to prevent pressure concentration on a portion of the bracket where the first fastening member 76 is fastened, the bracket 80 is coupled to the stator 67 to make a partial or overall point contact, a line contact or an in-plane contact therebetween. Hence, since compressive force is uniformly delivered to the stator 67, it can be brought into close contact with the bearing housing 60. Since the fastening force from the first fastening member 76 presses the stator 67 in a distributed state via the bracket 80, it is possible to prevent pressure concentration on a specific point and to maintain the concentricity of the stator 67. Further, since the concentricity between the bearing housing 60 and the stator 67 is maintained by the bracket 80, a distance between a rotor 69 disposed on the stator 67 and the shaft 52 can be uniformly maintained.

The slant section 88 of the bracket 80 extends into the stator 67 such that the bore 61 of the bearing housing 60 can be inserted into the penetration hole 86 that is formed at the center of the slant section 88. An inner side 80f of the bracket 80 is supported by a rear end 50f of the tub 50. The inner side 80f of the bracket 80 may be formed to have a bent inner periphery of the penetration hole 86. In one embodiment, the inner side 80f of the bracket 80 is configured to closely contact an outer peripheral surface of the rear end 50f of the tub 50. When the bracket 80 is closely coupled to the tub 50, the bracket 80 is supported by the rear end 50f of the tub 50 and allows vibration from the shaft 52 to be dispersed therethrough. Although the inner side 80f of the bracket 80 is supported by the rear end 50f of the tub 50 in this embodiment, but there can be various modifications of this embodiment. For example, the inner side 80f of the bracket 80 can be supported by a rear end of the bearing housing 60.

The bracket 80 is formed with one or more cooling holes 84, through which heat is emitted from the bearing housing 60 to the outside. Heat generated during operation of the washing machine is emitted through the cooling holes 84. The cooling holes 84 are formed between the coupling holes 82 and the penetration hole 86, or formed in the slant section 88. The cooling holes 84 are preferably formed on the overall surface of the bracket 80.

In this embodiment, the bearing housing 60, stator 67, and bracket 80 are coupled by a single kind of fastening member 76. However, the present invention is not limited to this construction, and for example, two of three members can be coupled in different manners by other kinds of fastening members.

Next, a method for assembling the washing machine constructed as described above according to one embodiment will be described as follows.

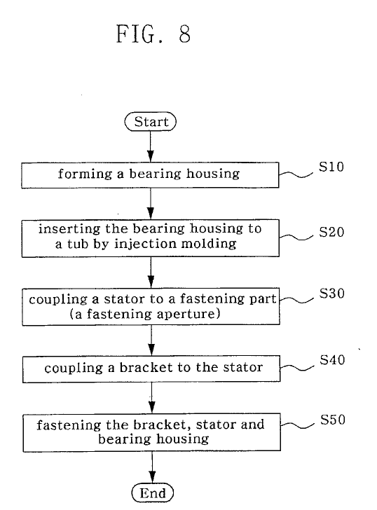

FIG. 8 is a flow chart of the method for assembling the washing machine according to the embodiment.

Referring to FIG. 8, a bearing housing 60 is first formed by injection molding and the like (S10). Then, with the bearing housing 60 supported by a jig (not shown), a tub 50 is formed by injection molding (S20). Here, the tub 50 may be molded to allow a fastening part 70 or a fastening aperture 72 of the bearing housing 60 to be exposed to the outside of the tub 50, and to allow the fastening part 70 or a portion 72c having the fastening aperture 72 formed therein to protrude from the rear wall of the tub 50. Further, during the injection molding, the housing 60 may supported by a jig on the fastening part 70 or the portion 72c having the fastening aperture 72 formed therein. As such, since the bearing housing 60 is inserted into the tub 50 in a state wherein the exposed fastening part 70 or the exposed portion 72c having the fastening aperture 72 formed therein, instead of a portion of the bearing housing 60 to be inserted into the tub 50, is supported by the jig, injection molding can be easily performed, thereby allowing the bearing housing 60 to be inserted into an accurate location while improving productivity.

After injection molding, a first fastening member 76 is coupled to a coupling hole 82, a through-hole 67a, and the fastening aperture 72, with a stator 67 and a bracket 80 disposed on the fastening part 70 of the bearing housing 60 (S30, S40, S50). At this time, since the bearing housing 60, the stator 67, and the bracket 80 are made of metal and supported in a close contact state with one another, they are stably supported, which enables concentricity thereof to be more effectively maintained.

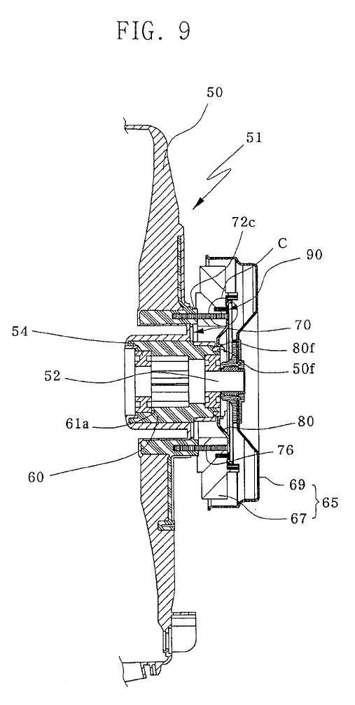

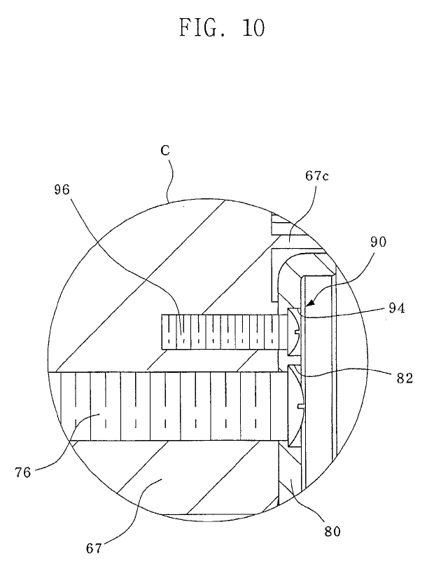

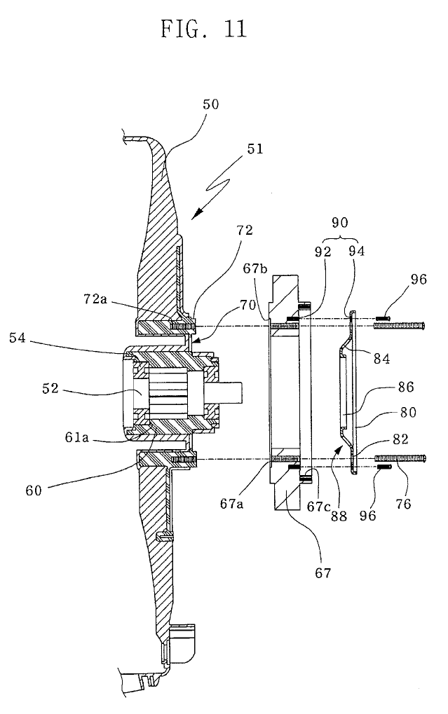

FIG. 9 is a cross-sectional view of a stator mounting structure of a washing machine according to another embodiment of the present invention, FIG. 10 is a detailed view of part C shown in FIG. 9, and FIG. 11 is an exploded cross-sectional view of the stator mounting structure of the washing machine according to another embodiment of the invention.

For convenience of description, substantially the same components as those of the above embodiment will be denoted by the same reference numerals, and a detailed description thereof will be omitted herein.

Referring to FIGS. 9 to 11, the washing machine of this embodiment includes a coupling part 90 for coupling the stator 67 to the bracket 80. The coupling part 90 includes a fastening hole 92 formed in the stator 67, and an assistant coupling part 94 formed in the bracket 80. The assistant coupling part 94 is formed at a location corresponding to the fastening hole 92. In the washing machine of this embodiment, the bearing housing 60, stator 67, and bracket 80 are coupled to one another by at least two operations, unlike the above embodiment wherein the components are coupled by a single operation. First, the stator 67 is coupled to the bracket 80 by a second fastening member 96. Then, the assembled stator 67 and bracket 80 is coupled to the bearing housing 60 by a first fastening member 76. Namely, in the above embodiment, three members, that is, the bearing housing 60, the stator 67 and the bracket 80, are simultaneously coupled to one another by a single fastening operation, whereas, in this embodiment, the stator 67 is coupled to the bracket 80, and the assembled stator 67 and bracket 80 is then coupled to the bearing housing 60, thereby improving assembling efficiency. Thus, in the washing machine of this embodiment, a motor 65 can be easily assembled, reducing time and cost for assembly.

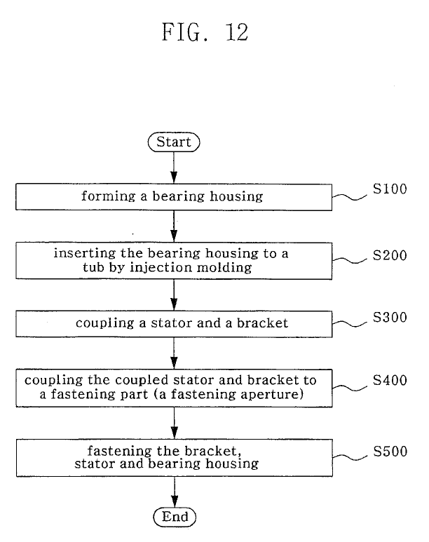

FIG. 12 is a flow chart of a method for assembling the washing machine according to another embodiment of the present invention.

Referring to FIG. 12, a bearing housing 60 is first formed by injection molding or die casting and the like (S100). Then, with the bearing housing 60 supported by a jig (not shown), a tub 50 is formed by injection molding (S200). Here, the tub 50 may be molded to allow a fastening part 70 or a fastening aperture 72 of the bearing housing 60 to be exposed to the outside of the tub 50, and to allow the fastening part 70 or a portion 72c having the fastening aperture 72 formed therein to protrude from the rear wall of the tub 50. Further, during the injection molding, the housing 60 may be supported by a jig on the portion 72c having the fastening part 70 or the fastening aperture 72 formed therein. As such, since the bearing housing 60 is inserted into the tub 50 in a state wherein, instead of a portion of the bearing housing 60 to be inserted into the tub 50, the exposed fastening part 70 or the exposed portion 72c having the fastening aperture 72 formed therein is supported by the jig, injection molding can be easily performed, thereby allowing the bearing housing 60 to be inserted into an accurate location while improving productivity.

After injection molding, the stator 67 is first coupled to the bracket 80 (S300). Then, the assembled stator 67 and bracket 80 is located on the fastening part 70 or the fastening aperture 72 (S400), and is coupled thereto by a fastening member (S500).

As apparent from the above description, in the washing machine according to the invention, a bearing housing is provided to the rear wall of a tub by injection molding without a separate fastening member that has been required to mount the bearing housing in the conventional technique, and to simplify mounting structure on the rear wall of the tub, thereby reducing time and cost for mounting a motor.

In addition, the bearing housing has a fastening part protruding from the rear wall of the tub such that the stator can be mounted to the fastening part. Hence, the bearing housing, made of metal, can be closely coupled to the stator, also made of metal, and thus deformation between the components is prevented when assembling the stator, so that the stator can be accurately assembled to a desired location.

As such, according to the invention, the fastening part of the bearing housing protrudes from the rear wall of the tub and allows the stator to be accurately mounted thereto. Hence, injection molding of the tub can be performed with the fastening part accurately disposed at a desired location by means of a jig, making it possible to maintain concentricity between the stator and the shaft. In this manner, since the concentricity of the stator and the shaft can be maintained, it is possible to reduce a distance between a drum and the tub, to which the stator and the shaft are coupled, enabling reduction in size of the washing machine.

In addition, according to the invention, a portion of the bearing housing having a fastening aperture formed therein protrudes from the rear wall of the tub, and the stator includes a latch jaw formed at a location corresponding to the fastening aperture. Therefore, when assembling the stator to the bearing housing, the portion having the fastening aperture formed therein is seated inside the latch jaw of the stator, allowing the stator to be accurately located. As a result, it is possible to maintain a uniform distance between the stator and a rotor, and to suppress noise from a motor.

In addition, according to the invention, since a bracket is provided to support the stator while compressing the stator toward the bearing housing, it is possible to improve fastening force between the bearing housing and the stator while preventing concentration of force on a specific portion, which prevents the stator from being biased when coupling the stator. Furthermore, with this configuration, the stator is suppressed from moving due to vibration generated during operation of the washing machine, thereby extending lifetime of the product.

Further, according to the invention, a coupling part is provided to couple the stator and the bracket. Accordingly, since the stator and the bracket can be coupled, and then in an assembled state be fastened to the bearing housing, it is possible to improve assembly efficiency and productivity.

Further, according to the invention, since an inner side of the bracket is supported by the rear end of the tub or by the rear end of the bearing housing, vibration can be more effectively dispersed from the shaft.

Further, according to the invention, with the exposed fastening part supported by the jig, the bearing housing is inserted to the tub, thereby enabling easy insert operation, improvement of productivity, and accurate placement of the bearing housing.

Although the present invention has been described with reference to the embodiments and drawings, the embodiments and drawings are given by way of illustration only, and, it will be apparent to those skilled in the art that various modifications and equivalent embodiments can be made without departing from the scope of the present invention. Further, although the present invention has been described based on the drum type washing machine, the drum type washing machine is given by way of illustration only, and the present invention can be naturally applied to other types of washing machine. Therefore, the scope of the present invention should be limited only by the accompanying claims.

What is claimed is:

1. A washing machine, comprising:
a tub;
a bearing housing provided to the tub by injection molding such that a fastening part is exposed to an outside of the tub; and
a stator coupled to the fastening part.

2. The washing machine according to claim 1, wherein the fastening part is disposed to protrude from a rear wall of the tub.

3. The washing machine according to claim 1, wherein the fastening part comprises a fastening aperture.

4. The washing machine according to claim 3, wherein the fastening aperture is threaded.

5. The washing machine according to claim 3, wherein a portion of the fastening part having the fastening aperture formed therein protrudes from the fastening part.

6. The washing machine according to claim 3, wherein the stator includes a latch jaw portion formed at a location of the stator corresponding to the location of the fastening aperture.

7. The washing machine according to claim 1, further comprising: a bracket configured to support the stator and to urge the stator toward the bearing housing.

8. The washing machine according to claim 7, wherein the fastening part is disposed to protrude from a rear wall of the tub.

9. The washing machine according to claim 7, wherein the fastening part comprises a fastening aperture, and a portion of the fastening part having the fastening aperture formed therein protrudes from the fastening part.

10. The washing machine according to claim 7, wherein the bracket is formed to include a coupling hole at location corresponding to a through-hole formed in the stator;
a penetration hole through which a shaft passes; and
a slant section in which a rim of the penetration hole is slanted toward the tub.

11. The washing machine according to claim 10, wherein the bracket further is formed to include a cooling hole through which heat generated from the bearing housing is emitted.

12. The washing machine according to claim 7, wherein an inner side of the bracket is supported by a rear end of the tub.

13. The washing machine according to claim 12, wherein the inner side of the bracket closely contacts an outer peripheral surface of the rear end of the tub.

14. The washing machine according to claim 7, wherein the inner side of the bracket is supported by a rear end of the bearing housing.

15. The washing machine according to claim 14, wherein the inner side of the bracket closely contacts an outer peripheral surface of the rear end of the bearing housing.

16. The washing machine according to claim 7, further comprising: a coupling part coupling the stator and the bracket.

17. The washing machine according to claim 16, wherein the coupling part comprises a fastening hole formed in the stator, and an assistant coupling part formed on the bracket at a location corresponding to the fastening hole.

18. A method for assembling a washing machine, comprising:
forming a bearing housing; and
inserting the bearing housing into a tub during injection molding of the tub, with the bearing housing supported by a jig, such that a fastening part of the bearing housing is exposed to an outside of the tub.

19. The method according to claim 18, wherein the step of inserting the bearing housing is performed such that the fastening part is formed to protrude to the outside of the tub.

20. The method according to claim 18, wherein the step of inserting the bearing housing is performed while the fastening part is supported by the jig.

21. The method according to claim 18, further comprising:
coupling a stator to the fastening part;
coupling a bracket to the stator; and
fastening the bracket, stator and fastening part with a fastening member.

22. A method for assembling a washing machine, comprising:
forming a bearing housing; and
inserting the bearing housing into a tub during injection molding of the tub, with the bearing housing supported by a jig, such that a fastening part of the bearing housing is exposed to an outside of the tub;
coupling a bracket and a stator;
coupling the coupled bracket and stator to the fastening part; and
fastening the bracket, stator and fastening part with a fastening member.

23. The method according to claim 22, wherein the step of inserting the bearing housing is performed such that the fastening part is formed to protrude to the outside of the tub.

24. The method according to claim 22, wherein the step of inserting the bearing housing is performed while the fastening part is supported by the jig.

25. A washing machine comprising:
a tub;
a bearing housing provided to the tub by injection molding such that a fastening aperture of the bearing housing is exposed to an outside of the tub; and
a stator coupled to the fastening aperture.
